(19) United States
(12) Patent Application Publication
(10) Pub. No.: US 2026/0320026 A1
(43) Pub. Date: Oct. 15, 2026

(54) METHOD AND SYSTEM FOR DATA RETRIEVAL CONSISTENCY

(71) Applicant: Visa International Service Association, San Francisco, CA (US)

(72) Inventors: Vinay Sarda, Bikaner (IN); Ravi Shanker Kumar Sinha, Bengaluru (IN); Mansi Singh, Bhopal (IN); Vikram Venkatesh Hegde, Bengaluru (IN)

(73) Assignee: Visa International Service Association, San Francisco, CA (US)

(21) Appl. No.: 19/179,579

(22) Filed: Apr. 15, 2025

(51) Int. Cl. G06F 16/23; G06F 16/27

(52) U.S. Cl. CPC G06F 16/2365; G06F 16/27

(57) ABSTRACT

A computer-implemented method is used with a plurality of database instances in an active-active replication mode. The computer-implemented method includes assigning unique identifiers to records inserted in the plurality of database instances, where the unique identifiers are based on instance-specific parities that indicate an insertion order unique to each of the plurality of database instances. The method also includes replicating, by a change data capture (CDC) API, the records across the plurality of database instances based on the unique identifiers while preserving insertion timestamps.

### BACKGROUND

In active-active database systems, multiple instances operate simultaneously to enhance performance and availability. This configuration, while beneficial, introduces significant challenges related to data consistency due to replication lag. When data is written to one instance, it is not immediately available in others, leading to potential inconsistencies. Traditional methods often rely on timestamps to track changes, but these can be unreliable in environments with asynchronous replication. The delay in data replication can result in discrepancies, where data retrieved from different instances may not match. This inconsistency poses a risk of data loss, especially when using Change Data Capture (CDC) APIs that depend on timely replication. Existing solutions attempt to mitigate this by implementing buffer periods, assuming data will replicate within a set timeframe, but this approach is not foolproof or efficient. The limitations of current methods highlight the need for a more robust solution to ensure data consistency across all instances. Buffer periods can fail if replication is delayed or interrupted, leading to missed data changes.

### SUMMARY

One general embodiment includes a computer-implemented method for use with a plurality of database instances in an active-active replication mode. The computer-implemented method also includes assigning unique identifiers to records inserted in the plurality of database instances, where the unique identifiers are based on instance-specific parities that indicate an insertion order unique to each of the plurality of database instances.

The method also includes replicating, by a change data capture (CDC) API, the records across the plurality of database instances based on the unique identifiers while preserving insertion timestamps. Other embodiments include corresponding computer systems, apparatus, and computer programs recorded on one or more computer storage devices, each configured to perform the actions of the computer-implemented.

Other implementations may include one or more of the following features. The computer-implemented method where replicating the records may include updating, by the CDC API, previously-stored minimum and maximum incremental values based on the unique identifiers associated with fetched records. The unique identifiers are independent of the insertion timestamps. The unique identifiers are based on auto-increment variables. The unique identifiers are each based on: an initial feed value unique to each of the plurality of database instances; and an incremental value. The unique identifiers may include different incremental values. Replicating the records may include retrieving records based on a range defined by a minimum incremental value and a maximum incremental value for each of the plurality of database instances. Replicating the records further may include storing and updating the minimum and maximum incremental values. The plurality of database instances may include a first database instance and a second database instance, where replicating the records may include: executing, by the CDC API, a fitch call to a first database instance of the plurality of database instances; and fetching, by the CDC API, records from the first database instance based on a stored unique identifier obtained in the previous fetch call by the CDC API to the first database. Replicating the records may include: updating, by the CDC API, the stored unique identifier based on the highest unique identifier of the fetched records. Replicating the records may include: inserting, by the CDC API, the fetched records into the second database instance while maintaining the unique identifiers and the original timestamps assigned to the fetched records when originally inserted into the first database instance.

One general embodiment includes a computer-implemented method. The computer implemented method also includes configuring a plurality of database instances with unique auto-increment settings; assigning based on the unique auto-increment settings unique identifiers to records inserted in the plurality of database instances, where the unique identifiers indicate an insertion order unique to each of the plurality of database instances; and replicating the records across the plurality of database instances based on the unique identifiers while preserving insertion timestamps.

Other Implementations may include one or more of the following features. The computer-implemented method where the unique identifiers are independent of the insertion timestamps. The unique identifiers are each based on: an initial feed value unique to each of the plurality of database instances; and an incremental value. Replicating the records may include retrieving records based on a range defined by a minimum incremental value and a maximum incremental value for each of the plurality of database instances. Replicating the records further may include storing and updating the minimum and maximum incremental values. The plurality of database instances may include a first database instance and a second database instance, where replicating the records may include: executing, by the CDC API, a fitch call to a first database instance of the plurality of database instances; and fetching, by the CDC API, records from the first database instance based on a stored unique identifier obtained in the previous fetch call by the CDC API to the first database. Replicating the records may include: updating, by the CDC API, the stored unique identifier based on the highest unique identifier of the fetched records. Replicating the records may include: inserting, by the CDC API, the fetched records into the second database instance while maintaining the unique identifiers and the original timestamps assigned to the fetched records when originally inserted into the first database instance.

One general embodiment includes a system. The system also includes a plurality of database instances with unique auto-increment configurations to generate distinct record identifiers, where the distinct record identifiers are unique to each of the plurality of database instances; and a Change Data Capture (CDC) API for replicating record changes across the plurality of database instances based on the distinct record identifiers while preserving insertion timestamps.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a method, in accordance with at least one embodiment of the present disclosure.

FIG. 2 illustrates a system, in accordance with at least one embodiment of the present disclosure.

FIG. 3 illustrates table outlining an operation of the system of FIG. 2.

FIG. 4 illustrates a method, in accordance with at least one embodiment of the present disclosure.

FIG. 5 is a block diagram of a computer apparatus with data processing subsystems or components, according to at least one aspect of the present disclosure.

FIG. 6 illustrates a system according to some embodiments of the present disclosure.

### DETAILED DESCRIPTION

The present disclosure provides, in some embodiments, methods and systems that address challenges associated with maintaining data consistency among replication-enabled databases, particularly in active-active configurations. Traditional database setups often struggle with data synchronization lags between replicated instances, leading to potential data loss or inconsistencies when retrieving information. This is especially problematic in active-active systems where both read and write operations occur concurrently across multiple database instances. The present disclosure provides various solutions to overcome these limitations, ensuring consistent and reliable data retrieval regardless of replication delays or failures. The solutions are particularly relevant in today's distributed computing environments where active-active configurations are increasingly prevalent.

The present disclosure provides various methods and systems that combine instance identification with incremental ordering of data changes. Unique mechanisms are provided for identifying the origin instance of each data record. The systems and methods may assign a unique identifier to records indicative of the records order in each instance. By knowing the origin instance, replication lags can be managed effectively. The unique identifiers may be implemented using various techniques, such as assigning specific auto-increment values or utilizing unique instance-specific metadata.

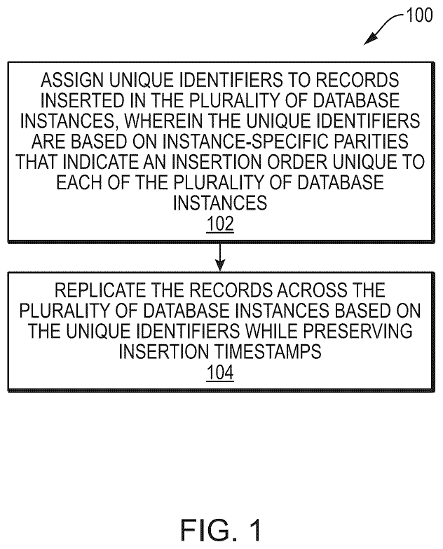

FIG. 1 illustrates a computer-implemented method 100 for use with a plurality of database instances in an active-active replication mode, in accordance with at least one embodiment of the present disclosure. The method 100 includes assigning 102 unique identifiers to records inserted in the plurality of database instances. The unique identifiers are based on instance-specific parities. The instance-specific parities may indicate an insertion order unique to each of the plurality of database instances. The method 100 further includes replicating 104 the records across the plurality of database instances based on the unique identifiers. The replication may be performed independently of insertion timestamps and/or while preserving insertion timestamps.

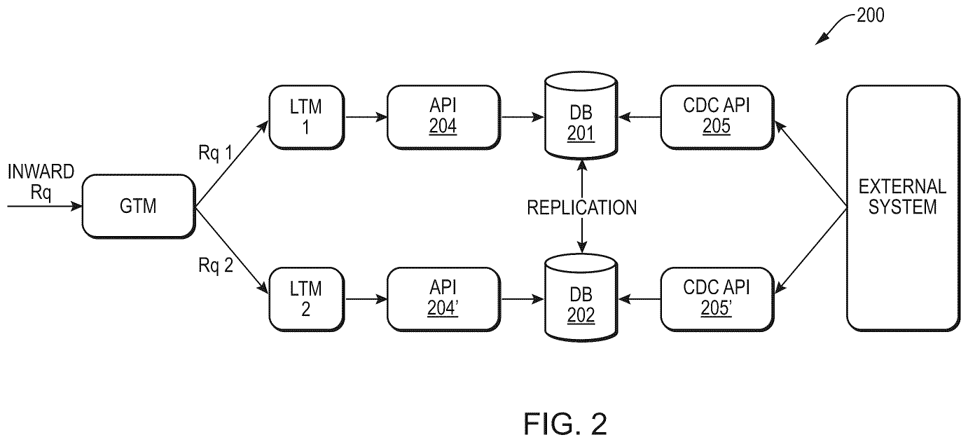

FIG. 2 illustrates a system 200, in accordance with at least one embodiment of the present disclosure. One or more components of the system 200 may be utilized to perform one or more steps the method 100 and/or other methods disclosed herein. The system 200 may include a plurality of database instances (e.g., database instances 201, 202) that may be configured in an active-active replication mode.

The system 200 may include one or more change data capture (CDC) APIs (e.g. CDC API 205, 205′) and one or more APIs (e.g., 204, 204′). The CDC APIs may capture and track data modifications across databases instances. In at least one embodiment, The CDC API may monitor and record all changes occurring within each database instance. The CDC API may be implemented using various techniques, such as database triggers or log-based capture mechanisms. In some embodiments, the plurality of database instances of the system 200 may receive records from local traffic managers (LTM). A global traffic manager (GTM) may route the records to the LTMs for insertion into the database instances via APIs 204, 204′.

The method 100 may include configuring the database instances with auto-increment variables to generate unique identifiers with different incremental values. In some embodiments, the unique identifiers assigned to the records are independent of the insertion timestamps. Each of the unique identifiers may be based on an initial feed value unique to each of the plurality of database instances, and an incremental value.

Replicating the records, in accordance with the method 100, may include selectively retrieving records based on a range defined by a minimum incremental value and a maximum incremental value for each of the plurality of database instances. Additionally, the method 100 may further include storing and updating the minimum and maximum incremental values for each of the plurality of database instances, as described in greater detail below.

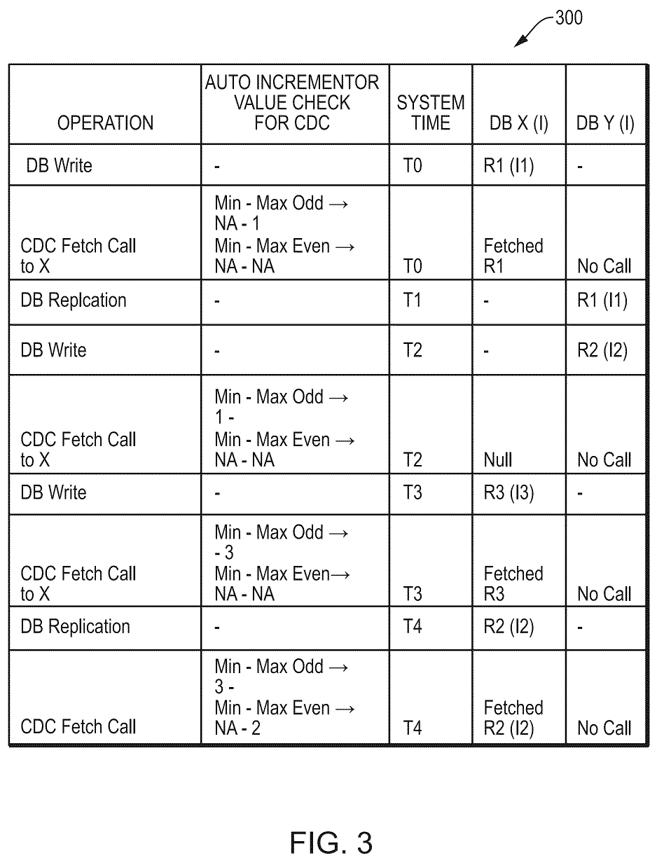

FIG. 3 is a table illustrating an operation of the system 200, in accordance with at least one embodiment of the method 100. Database instances 201 and 202 are represented as instances X, Y, respectively, with odd and even increment values, respectively, for the unique identifiers. The system 200 may utilize an auto-incrementing variable, referred to as the “I column,” within the database instances. This column is configured differently for each instance, using distinct initial feed and increment values. For example, in the two-instance setup (X and Y), instance X could have a feed value of 1 and an increment of 2, while instance Y has a feed value of 2 and an increment of 2. This configuration ensures that records originating from instance X always have odd I column values, and those from instance Y have even values.

In one non-limiting example, five records are inserted in instance X and ten in instance Y. The I column values would be (1, 2, 3, 4, 5, 6, 7, 8, 9, 10, 12, 14, 16, 18, 20). The CDC API, on its first call, identifies the min/max odd as 1 and 9, and min/max even as 2 and 20. It then retrieves records within these ranges. If two more records are inserted in instance X, the I column values become (1, 2, 3, 4, 5, 6, 7, 8, 9, 10, 11, 12, 13, 14, 16, 18, 20). The CDC API, knowing it last fetched up to 9 for odd and 20 for even, checks for higher values. It finds 11 and 13 for odd and retrieves those records. No new even records exist, so none are fetched.

Referring to FIG. 3, initially, a record R1 is written to Instance X at time T0 with an auto-increment value of I1. The CDC API calls Instance X for newly available data, fetching record R1, with the minimum and maximum odd values being NA and 1, respectively, and no even values available. Consequently, record R1 is fetched with the incrementor value of I1. At T1, record R1 is replicated to Instance Y, maintaining the auto-increment value I1.

At T2, record R2 is written to Instance Y with an auto-increment value I2. However, when the CDC API calls Instance X for newly available data at T2, nothing is fetched because no new record is available in X, with the minimum and maximum odd values being 1 and NA, respectively, and no even values available. At T3, record R3 is written to Instance X with an auto-increment value I3. The CDC API fetches this newly available record in X, with the minimum and maximum odd values being 1 and 3, respectively, and no even values available. Thus, record R3 is fetched with an incrementor value of I3.

At T4, record R2 is replicated to Instance X, maintaining the auto-increment value I2. The CDC API then calls Instance X for newly available data, fetching record R2 with an incrementor value of I2, as the minimum and maximum odd values are 3 and NA, respectively, and the even values are NA and 2.

The incremental order allows the system to manage data changes efficiently, even in the presence of replication delays. By maintaining a precise sequence of changes, the disclosure ensures that all data modifications are captured and retrieved accurately. This approach is particularly beneficial in environments with high transaction volumes, where maintaining the order of operations is critical.

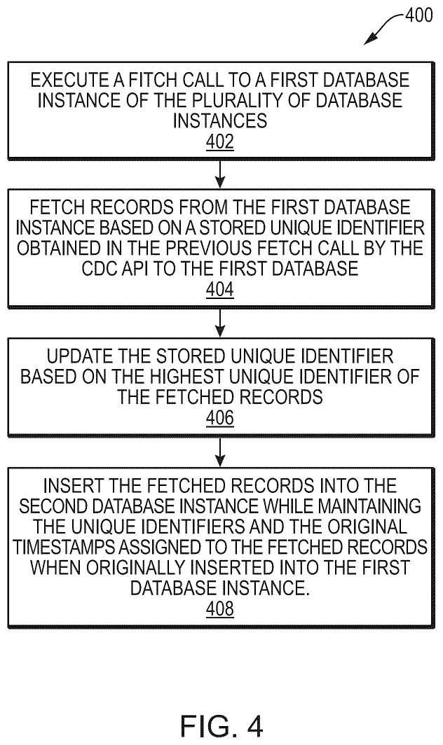

FIG. 4 illustrates a computer-implemented method 400, in accordance with at least one embodiment of the present disclosure. In some embodiments, the record replication 104 of the method 100 may be performed by the system 200 in accordance with the method 400. The system 200 may execute 402 a fitch call to a first database instance of the plurality of database instances and may fetch 404 records from the first database instance based on a stored unique identifier obtained in the previous fetch call by the CDC API to the first database. Additionally, the system 200 may further update 406 the stored unique identifier based on the highest unique identifier of the fetched records. Furthermore, the system 200 may insert 408 the fetched records into the second database instance while maintaining the unique identifiers and the original timestamps assigned to the fetched records when originally inserted into the first database instance.

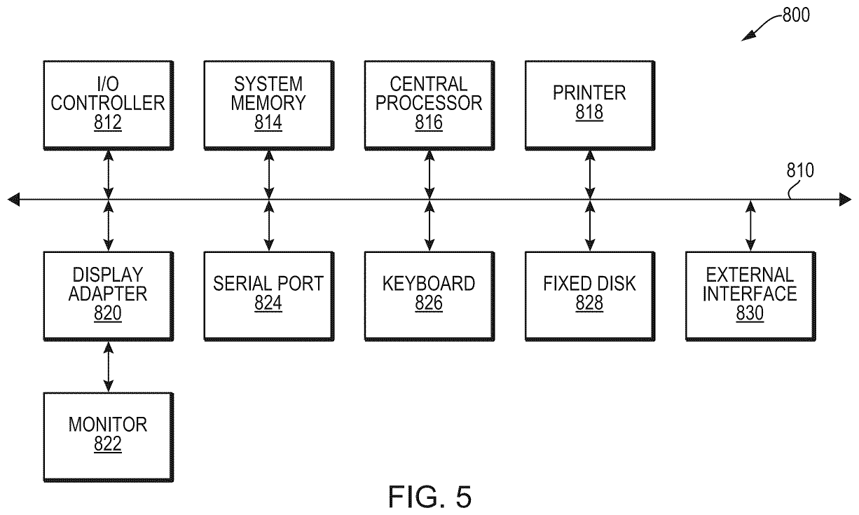

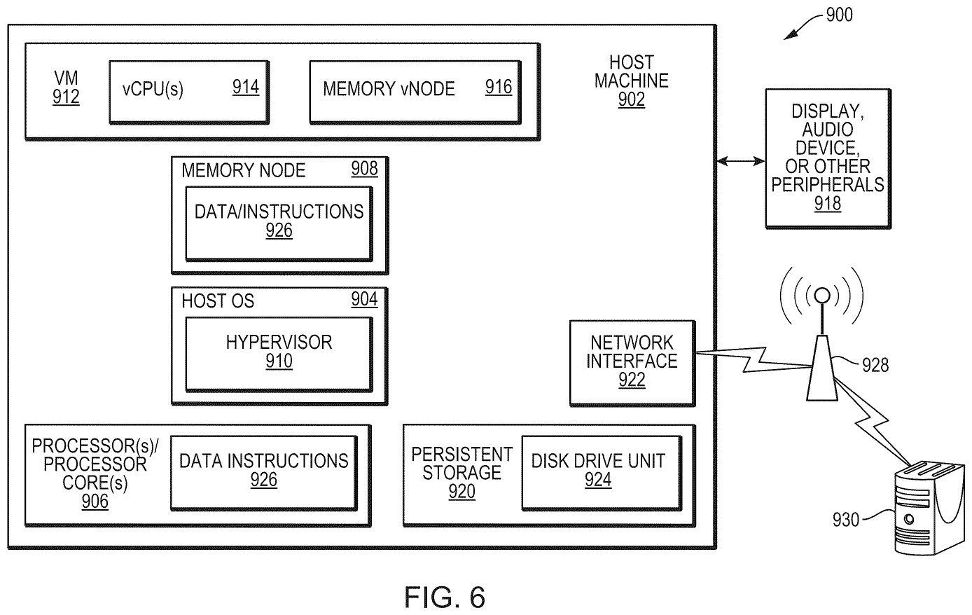

The systems and methods, as described in connection with FIGS. 1-4 may include, or make use of, a number of computer apparatuses, computer systems, or the like. In other words, to utilize the systems and methods disclosed herein, at least one of a computer apparatus, computer system, or the like may be implemented. Each of these computer apparatuses, computer systems, or the like are described in greater detail below with respect to the computer apparatus 800 shown in FIG. 5 and the example system 900 shown in FIG. 6, which provide a connection between the solution disclosed herein and how such a solution may be implemented within a business entity, such as a payment network, a processing network, a payment processing network, or the like.

FIG. 5 is a block diagram of a computer apparatus 800 with data processing subsystems or components, according to at least one aspect of the present disclosure. The subsystems shown in FIG. 5 are interconnected via a system bus 810. Additional subsystems such as a printer 818, keyboard 826, fixed disk 828 (or other memory comprising computer-readable media), monitor 822 (which is coupled to a display adapter 820), and others are shown. Peripherals and input/output (I/O) devices, which couple to an I/O controller 812 (which can be a processor or other suitable controller), can be connected to the computer system by any number of means known in the art, such as a serial port 824. For example, the serial port 824 or external interface 830 can be used to connect the computer apparatus to a wide area network such as the Internet, a mouse input device, or a scanner. The interconnection via system bus 810 allows the central processor 816 to communicate with each subsystem and to control the execution of instructions from system memory 814 or the fixed disk 828, as well as the exchange of information between subsystems. The system memory 814 and/or the fixed disk 828 may embody a computer-readable medium.

FIG. 6 is a diagrammatic representation of an example system 900 that includes a host machine 902 within which a set of instructions to perform any one or more of the methodologies discussed herein may be executed, according to at least one aspect of the present disclosure. In various aspects, the host machine 902 operates as a stand-alone device or may be connected (e.g., networked) to other machines. In a networked deployment, the host machine 902 may operate in the capacity of a server or a client machine in a server-client network environment, or as a peer machine in a peer-to-peer (or distributed) network environment. The host machine 902 may be a computer or computing device, a personal computer (PC); a tablet PC; a set-top box; a personal digital assistant; a cellular telephone; a portable music player (e.g., a portable hard drive audio device, such as an Moving Picture Experts Group Audio Layer 3 (MP3) player); a web appliance; a network router, switch, or bridge; or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 900 includes the host machine 902, running a host operating system (OS) 904 on a processor or multiple processor(s)/processor core(s) 906 (e.g., a central processing unit (CPU), a graphics processing unit, or both), and various memory nodes 908. The host OS 904 may include a hypervisor 910, which is able to control the functions and/or communicate with a virtual machine (VM) 912 running on machine-readable media. The VM 912 also may include a virtual CPU or vCPU 914. The memory nodes 908 may be linked or pinned to virtual memory nodes or vNodes 916. When the memory node 908 is linked or pinned to a corresponding vNode 916, then data may be mapped directly from the memory nodes 908 to their corresponding vNodes 916.

All the various components shown in host machine 902 may be connected with and to each other or communicate to each other via a bus (not shown) or via other coupling or communication channels or mechanisms. The host machine 902 may further include a video display, audio device, or other peripherals 918 (e.g., a liquid crystal display; alpha-numeric input device(s) including, e.g., a keyboard; a cursor control device, e.g., a mouse; a voice recognition or biometric verification unit; an external drive; a signal generation device, e.g., a speaker); a persistent storage device 920 (also referred to as disk drive unit); and a network interface device 922. The host machine 902 may further include a data encryption module (not shown) to encrypt data. The components provided in the host machine 902 are those typically found in computer systems that may be suitable for use with aspects of the present disclosure and are intended to represent a broad category of such computer components that are known in the art. Thus, the system 900 can be a server, minicomputer, mainframe computer, or any other computer system. The computer may also include different bus configurations, networked platforms, multi-processor platforms, and the like. Various OSs may be used, including UNIX, LINUX, WINDOWS, QNX ANDROID, IOS, CHROME, TIZEN, and other suitable OSs.

The disk drive unit 924 also may be a solid-state drive, a hard disk drive, or other drive that includes a computer or machine-readable medium on which is stored one or more sets of instructions and data structures (e.g., data/instructions 926) embodying or utilizing any one or more of the methodologies or functions described herein. The data/instructions 926 also may reside, completely or at least partially, within the main memory node 908 and/or within the processor(s) 906 during execution thereof by the host machine 902. The data/instructions 926 may further be transmitted or received over a network 928 via the network interface device 922 utilizing any one of several well-known transfer protocols (e.g., Hyper Text Transfer Protocol (HTTP)).

The processor(s) 906 and memory nodes 908 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 902 and that causes the host machine 902 to perform any one or more of the methodologies of the present application or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read-only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service and that the computing devices may include one or more processors, buses, memory devices, display devices, I/O devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

Suitable networks may include or interface with any one or more of, for instance, a local intranet; a personal area network (PAN); a local area network (LAN); a wide area network (WAN); a metropolitan area network (MAN); a virtual private network (VPN); a storage area network (SAN); a frame relay connection; an advanced intelligent network (AIN) connection; a synchronous optical network (SONET) connection; a digital T1, T3, E1, or E3 line; a digital data service (DDS) connection; a digital subscriber line (DSL) connection; an Ethernet connection; an integrated services digital network (ISDN) line; a dial-up port, such as a V.90, V.34, or V.34bis analog modem connection; a cable modem; an Asynchronous Transfer Mode (ATM) connection; or an Fiber Distributed Data Interface (FDDI) or Copper Distributed Data Interface (CDDI) connection. Furthermore, communications may also include links to any of a variety of wireless networks, including Wireless Application Protocol (WAP), General Packet Radio Service (GPRS), Global System for Mobile Communication (GSM), Code Division Multiple Access (CDMA) or Time Division Multiple Access (TDMA), cellular phone networks, global positioning system (GPS), cellular digital packet data (CDPD), Research in Motion, Limited (RIM) duplex paging network, Bluetooth radio, or an Institute of Electrical and Electronics Engineers (IEEE) 802.11-based radio frequency (RF) network. The network 928 can further include or interface with any one or more of an RS-232 serial connection, an IEEE-1394 (Firewire) connection, a Fiber Channel connection, an IrDA (infrared (IR)) port, a Small Computer Systems Interface (SCSI) connection, a Universal Serial Bus (USB) connection or other wired or wireless, digital, or analog interface or connection, mesh, or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 902, with each server 930 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during RF and IR data communications. Common forms of computer-readable media include, for example, a flexible disk, a hard disk, magnetic tape, any other magnetic medium, a compact disc ROM (CD-ROM) disk, digital video disc, any other optical medium, any other physical medium with patterns of marks or holes, a RAM, a programmable ROM, an erasable programmable ROM (EPROM), an electrically erasable programmable ROM (EEPROM), a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a LAN or a WAN, or the connection may be made to an external computer (for example, through the Internet using an Internet service provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms, and an illustrative form of the subject matter described herein applies regardless of the particular type of signal-bearing medium used to actually carry out the distribution.

Instructions used to program logic to perform various disclosed aspects can be stored within a memory in the system, such as dynamic RAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), including, but not limited to, floppy diskettes, optical disks, CD-ROMs, magneto-optical disks, ROM, RAM, EPROM, EEPROM, magnetic or optical cards, flash memory, or a tangible, machine-readable storage used in the transmission of information over the Internet via electrical, optical, acoustical, or other forms of propagated signals (e.g., carrier waves, IR signals, digital signals). Accordingly, the non-transitory computer-readable medium includes any type of tangible machine-readable medium suitable for storing or transmitting electronic instructions or information in a form readable by a machine (e.g., a computer).

Any of the software components or functions described in this application may be implemented as software code to be executed by a processor using any suitable computer language, such as, for example, Python, Java, C++, or Perl, using, for example, conventional or object-oriented techniques. The software code may be stored as a series of instructions or commands on a computer-readable medium, such as RAM, ROM, a magnetic medium such as a hard drive or a floppy disk, or an optical medium such as a CD-ROM. Any such computer-readable medium may reside on or within a single computational apparatus and may be present on or within different computational apparatuses within a system or network.

As used in any aspect herein, the term “logic” may refer to an app, software, firmware, and/or circuitry configured to perform any of the aforementioned operations. Software may be embodied as a software package, code, instructions, instruction sets, and/or data recorded on a non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

A network may include a packet-switched network. The communication devices may be capable of communicating with each other using a selected packet-switched network communications protocol. One example communications protocol may include an Ethernet communications protocol, which may be capable of permitting communication using a Transmission Control Protocol/Internet Protocol. The Ethernet protocol may comply or be compatible with the Ethernet standard published by the IEEE titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector. Alternatively, or additionally, the communication devices may be capable of communicating with each other using a frame relay communications protocol. The frame relay communications protocol may comply or be compatible with a standard promulgated by Consultative Committee for International Telegraph and Telephone and/or the American National Standards Institute. Alternatively, or additionally, the transceivers may be capable of communicating with each other using the ATM communications protocol. The ATM communications protocol may comply or be compatible with an ATM standard published by the ATM Forum titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like refer to the action and processes of a computer system, or similar electronic computing device, that manipulates and transforms data represented as physical (electronic) quantities within the computer system's registers and memories into other data similarly represented as physical quantities within the computer system memories, registers, or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense one having skill in the art would understand the convention (e.g., “a system having at least one of A, B, or C” would include, but not be limited to, systems that have A alone, B Attorney alone, C alone, A and B together, A and C together, B and C together, and/or A, B, and C together). It will be further understood by those skilled in the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A,” “B,” or “A and B.”

With respect to the appended claims, those skilled in the art will appreciate that recited operations therein may generally be performed in any order. Also, although various operational flow diagrams are presented in sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the features, structures, or characteristics may be combined in any suitable manner in one or more aspects.

As used herein, the singular form of “a,” “an,” and “the” include the plural references unless the context clearly dictates otherwise.

In summary, numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described to illustrate principles and practical application to thereby enable one of ordinary skill in the art to utilize the various forms with various modifications as are suited to the particular use contemplated. It is intended that the claims submitted herewith define the overall scope.

What is claimed is:

1. A computer-implemented method for use with a plurality of database instances in an active-active replication mode, the method comprising:
assigning unique identifiers to records inserted in the plurality of database instances, wherein the unique identifiers are based on instance-specific parities that indicate an insertion order unique to each of the plurality of database instances; and
replicating, by a change data capture (CDC) API, the records across the plurality of database instances based on the unique identifiers while preserving insertion timestamps.

2. The computer-implemented method of claim 1, wherein replicating the records comprises updating, by the CDC API, previously-stored minimum and maximum incremental values based on the unique identifiers associated with fetched records.

3. The computer-implemented method of claim 1, wherein the unique identifiers are independent of the insertion timestamps.

4. The computer-implemented method of claim 1, wherein the unique identifiers are based on auto-increment variables.

5. The computer-implemented method of claim 1, wherein the unique identifiers are each based on:
an initial feed value unique to each of the plurality of database instances; and
an incremental value.

6. The computer-implemented method of claim 1, wherein the unique identifiers comprise different incremental values.

7. The computer-implemented method of claim 1, wherein replicating the records comprises retrieving records based on a range defined by a minimum incremental value and a maximum incremental value for each of the plurality of database instances.

8. The computer-implemented method of claim 7, wherein replicating the records further comprises storing and updating the minimum and maximum incremental values.

9. The computer-implemented method of claim 1, wherein the plurality of database instances comprises a first database instance and a second database instance, wherein replicating the records comprises:
executing, by the CDC API, a fitch call to a first database instance of the plurality of database instances; and
fetching, by the CDC API, records from the first database instance based on a stored unique identifier obtained in the previous fetch call by the CDC API to the first database.

10. The computer-implemented method of claim 9, wherein replicating the records comprises:
updating, by the CDC API, the stored unique identifier based on the highest unique identifier of the fetched records.

11. The computer-implemented method of claim 10, wherein replicating the records comprises:
inserting, by the CDC API, the fetched records into the second database instance while maintaining the unique identifiers and the original timestamps assigned to the fetched records when originally inserted into the first database instance.

12. A computer-implemented method, comprising:
configuring a plurality of database instances with unique auto-increment settings;
assigning based on the unique auto-increment settings unique identifiers to records inserted in the plurality of database instances, wherein the unique identifiers indicate an insertion order unique to each of the plurality of database instances; and
replicating the records across the plurality of database instances based on the unique identifiers while preserving insertion timestamps.

13. The computer-implemented method of claim 12, wherein the unique identifiers are independent of the insertion timestamps.

14. The computer-implemented method of claim 12, wherein the unique identifiers are each based on:
an initial feed value unique to each of the plurality of database instances; and
an incremental value.

15. The computer-implemented method of claim 12, wherein replicating the records comprises retrieving records based on a range defined by a minimum incremental value and a maximum incremental value for each of the plurality of database instances.

16. The computer-implemented method of claim 15, wherein replicating the records further comprises storing and updating the minimum and maximum incremental values.

17. The computer-implemented method of claim 12, wherein the plurality of database instances comprises a first database instance and a second database instance, wherein replicating the records comprises:
executing, by the CDC API, a fitch call to a first database instance of the plurality of database instances; and
fetching, by the CDC API, records from the first database instance based on a stored unique identifier obtained in the previous fetch call by the CDC API to the first database.

18. The computer-implemented method of claim 17, wherein replicating the records comprises:
updating, by the CDC API, the stored unique identifier based on the highest unique identifier of the fetched records.

19. The computer-implemented method of claim 18, wherein replicating the records comprises:
inserting, by the CDC API, the fetched records into the second database instance while maintaining the unique identifiers and the original timestamps assigned to the fetched records when originally inserted into the first database instance.

20. A system, comprising:
a plurality of database instances with unique auto-increment configurations to generate distinct record identifiers, wherein the distinct record identifiers are unique to each of the plurality of database instances; and
a Change Data Capture (CDC) API for replicating record changes across the plurality of database instances based on the distinct record identifiers while preserving insertion timestamps.
